(19) United States
(12) Patent Application Publication
(10) Pub. No.: US 2025/0035580 A1
(43) Pub. Date: Jan. 30, 2025

(54) GAS SENSOR

(71) Applicant: DENSO CORPORATION, Kariya-city (JP)

(72) Inventor: Shinichiro IMAMURA, Kariya-city (JP)

(21) Appl. No.: 18/910,295

(22) Filed: Oct. 9, 2024

Related U.S. Application Data
(63) Continuation of application No. PCT/JP2023/010186, filed on Mar. 15, 2023.

(30) Foreign Application Priority Data
Apr. 15, 2022 (JP) 2022-067454

(51) Int. Cl. G01N 27/409; G01M 15/10

(52) U.S. Cl. CPC G01N 27/409; G01M 15/102

(57) ABSTRACT

A gas sensor has a sensor element measuring a gas concentration, an insulator holding the sensor element, a sealing member disposed in a concave portion of the insulator, and a housing holding the insulator. The concave portion of the insulator is communicated with an insertion hole through which the sensor element is inserted, and the sensor element is disposed in thereof. An opening edge portion in an inner bottom of the concave portion, which connects to the insertion hole, protrudes more than other portions surrounding the opening edge portion.

### CROSS-REFERENCE TO RELATED APPLICATION

The present application is a continuation application of International Application No. PCT/JP2023/010186, filed on Mar. 15, 2023, which claims priority to Japanese Patent Application No. 2022-067454, filed in Japan on Apr. 15, 2022. The contents of these applications are incorporated herein by reference in their entirety.

### BACKGROUND

### 1. Technical Field

The present disclosure relates to a gas sensor.

### 2. Related Art

The gas sensor is used to measure a concentration of gases such as oxygen gas and other specific gases contained in measurement gas such as exhaust gas. The gas sensor uses a sensor element with a detection electrode exposed to the measurement gas and a reference electrode exposed to the air. The gas sensor uses a sealing structure to prevent the measurement gas from leaking into the air through a gap between the sensor element and an insulator retaining the sensor element.

### SUMMARY

The present disclosure provides a gas sensor. As an aspect of the present disclosure, a gas sensor includes a sensor element, an insulator, a sealing member, and a housing. The sensor element measures a gas concentration. The insulator has an insertion hole through which the sensor element is inserted, and a concave portion, in which the sensor element communicated with the insertion hole is continuously disposed from the insertion hole. The sealing member is disposed in the concave portion to hold the sensor element to the insulator. The housing is formed with a retaining hole to hold the insulator. An opening edge portion in the inner bottom surface of the concave portion, which connects to the insertion hole, protrudes more than other portions surrounding the opening edge portion.

### BRIEF DESCRIPTION OF THE DRAWINGS

In the accompanying drawings:

FIG. 1 is an illustrative diagram showing a cross-section of a gas sensor according to an embodiment;

FIG. 2 is an illustrative diagram showing a cross-section of a sensor element of the gas sensor according to the embodiment;

FIG. 3 is an illustrative diagram showing a cross-section across a line III-III in FIG. 2 according to the embodiment;

FIG. 4 is an illustrative diagram showing a cross-section across a line IV-IV in FIG. 2 according to the embodiment;

FIG. 5 is an illustrative diagram showing an intermediate body in which the sensor element, an insulator, and a sealing member are assembled;

FIG. 6 is an enlarged diagram showing a portion of FIG. 5; and

FIG. 7 is an enlarged diagram showing a portion of an intermediate body with a different configuration of the sealing member.

### DETAILED DESCRIPTION OF THE PREFERRED EMBODIMENTS

For example, JP 2002-82089 A discloses a gas sensor in which a gap between an inner surface of the insulator and an outer surface of the sensor element are sealed by a glass sealing material. JP 2002-82089 A also discloses that parts of a contact interface between the glass sealing material and the insulator and a contact interface between the glass sealing material and the sensor element, protrude more than other portions.

A technology described in JP 2002-82089 A enhances the sealing effect between the insulator and the sensor element by the deformation that occurs in a shape of the glass sealing material when the glass sealing material melts and solidifies. In other words, JP 2002-82089 A does not describe the detailed method of improving the shape of a concave portion of the insulator in which the glass sealing material is housed. Therefore, further improvement is required to enhance the sealing effect of the glass sealing material.

The present disclosure is to provide a gas sensor that can effectively enhance the sealing effect between the insulator and the sensor element when using a sealing member.

An aspect of the present disclosure is a gas sensor including:
a sensor element measuring a gas concentration;
an insulator having:
   an insertion hole through which the sensor element is inserted; and
   a concave portion, in which the sensor element communicated with the insertion hole is continuously disposed from the insertion hole,
a sealing member which is disposed in the concave portion to hold the sensor element to the insulator; and
a housing with a retaining hole to hold the insulator, wherein
an opening edge portion in the inner bottom surface of the concave portion, which connects to the insertion hole, protrudes more than other portions surrounding the opening edge portion.

In the gas sensor described above, the opening edge portion connected to the insertion hole in the inner bottom surface of the concave portion of the insulator protrudes more than the other portions surrounding the opening edge portion do. With this configuration, the sealing member is disposed in the concave portion of the insulator, and when the sensor element is retained in the insulator, the sealing member contacts the opening edge portion protruding from the inner bottom of the concave portion. Thus, the gas sensor can easily allow the sealing member to contact the insulator. Further, the gas sensor can increase a contact area between the sealing member and the insulator by having the sealing member contact the opening edge portion.

According to the gas sensor described above, it is possible to effectively enhance the sealing effect between the insulator and the sensor element when using the sealing member. The above-described object and other objects as well as the characteristics and advantages of the present disclosure will be further clarified by the following detailed description with reference to the accompanying drawings.

The preferred embodiments for the above gas sensor will be described with reference to the drawings.

### EMBODIMENT

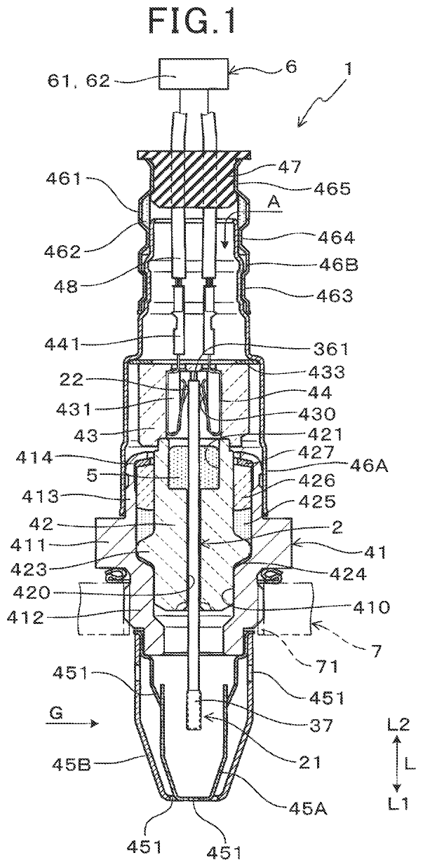

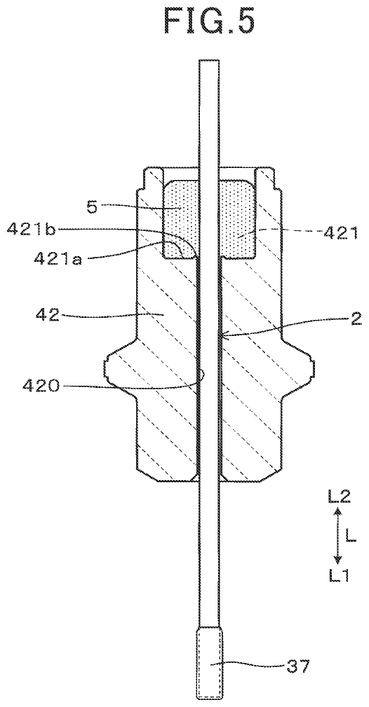

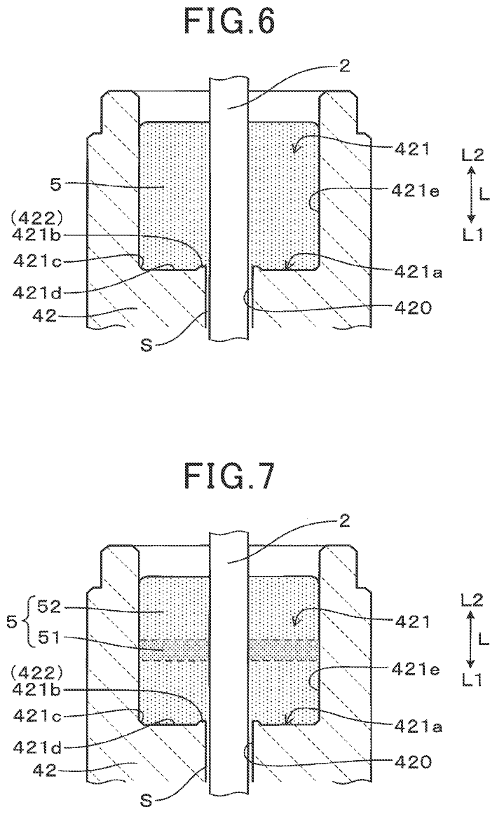

As shown in FIG. 1, a gas sensor 1, according to the present embodiment, includes a sensor element 2, an insulator 42, a sealing member 5, and a housing 41. The sensor element 2 is an element that measures a gas concentration. The housing 41 has a retaining hole 410 retaining the insulator 42. As shown in FIG. 5, the insulator 42 has an insertion hole 420 through which the sensor element 2 is inserted and a concave portion 421 in which the sensor element 2 communicated with the insertion hole 420 is continuously disposed from the insertion hole 420. The sealing member 5 is disposed in the concave portion 421 to hold the sensor element 2 to the insulator 42. As shown in FIG. 6, an opening edge portion 421b in an inner bottom surface 421a of the concave portion 421, which connects to the insertion hole 420, protrudes more than other portions surrounding the opening edge portion 421b.

Hereinafter, the gas sensor 1, according to the present embodiment, will be described in detail.

### Gas Sensor 1

As shown in FIG. 1, the gas sensor 1 is disposed to a mounting opening 71 of an exhaust pipe 7 of an internal combustion engine of a vehicle. The gas sensor 1 is used to measure a concentration of oxygen, a concentration of specific gases, or the like, as measurement gas contained in an exhaust gas G flowing through the exhaust pipe 7. The gas sensor 1 may be used as an air-fuel ratio sensor (A/F sensor) to measure an air-fuel ratio in the internal combustion engine based on the concentration of oxygen, a concentration of unburned gas, and the like, in the exhaust gas G.

A catalyst is disposed in the exhaust pipe 7 to purify harmful substances in the exhaust gas G. The gas sensor 1 may be disposed of either upstream or downstream of the catalyst in a direction in which the exhaust gas G flows in the exhaust pipe 7. The gas sensor 1 may also be disposed in an intake pipe of a charger that increases a density of the air sucked by the internal combustion engine by using the exhaust gas G. A pipe in which the gas sensor 1 is disposed may be a pipe of an exhaust recirculation mechanism that recirculates part of the exhaust gas G, which is exhausted from the internal combustion engine to the exhaust pipe 7, to the intake pipe of the internal combustion engine.

### Sensor Element 2

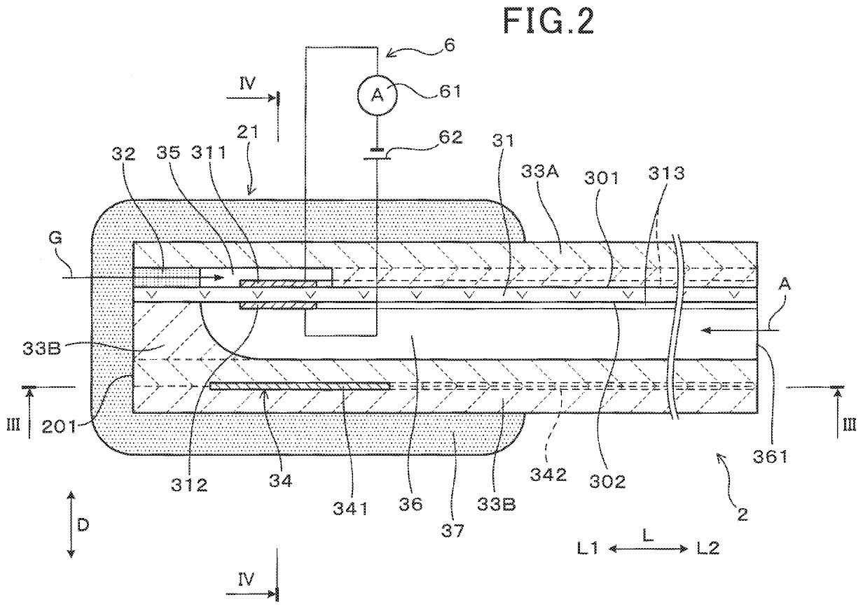

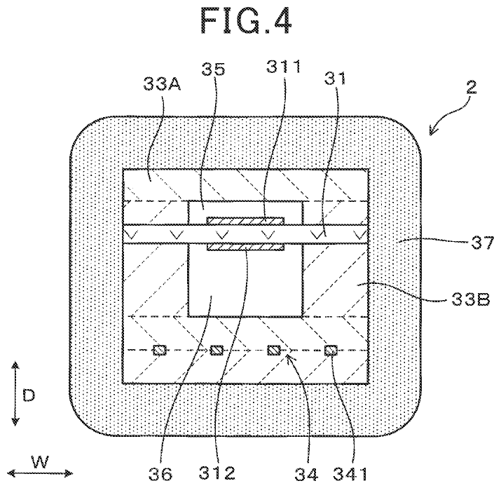

As shown in FIGS. 2 to 4, the sensor element 2, according to the present embodiment, is formed in a long rectangular shape. The sensor element 2 includes a solid electrolyte body 31, an exhaust electrode 311, an air electrode 312, a first insulator 33A, a second insulator 33B, a gas chamber 35, an air duct 36, and a heater element 34. The sensor element 2 is of a lamination type in which each insulator 33A and 33B and the heater element 34 are laid on the solid electrolyte body 31.

In the present embodiment, a lengthwise direction L of the sensor element 2 is a direction in which the sensor element 2 extends in a long shape. A lamination direction D of the sensor element 2 is orthogonal to the lengthwise direction L and is a direction in which the solid electrolyte body 31 and each insulator 33A, 33B are laminated. In other words, the lamination direction D is referred to as a direction in which the solid electrolyte body 31, each insulator 33A, 33B, and the heater element 34 are laminated. A width direction W of the sensor element 2 is orthogonal to the lengthwise direction L and the lamination direction D. In the lengthwise direction L of the sensor element 2, a side exposed to the exhaust gas G is referred to as a tip side L1, and a side opposite to the tip side L1 is referred to as a base side L2.

### Solid Electrolyte Body 31, Exhaust Electrode 311, and Air Electrode 312

As shown in FIGS. 2 to 4, the solid electrolyte body 31 has conductivity of oxygen ions (O²⁻) at a predetermined activation temperature. The exhaust electrode 311, which is exposed to the exhaust gas G, is disposed on a first surface 301 of the solid electrolyte body 31. The air electrode 312, which is exposed to air A, is disposed on a second surface 302 of the solid electrolyte body 31. The exhaust electrode 311 and the air electrode 312 are disposed so as to overlap each other in the lamination direction D via the solid electrolyte element 31 at a part on the tip side L1, which is exposed by the exhaust gas G, of the sensor element 2 in the lengthwise direction L. A part on the tip side L1 of the sensor element 2 in the lengthwise direction L is provided with a detector 21. The detector 21 is configured to include the exhaust electrode 311 and the air electrode 312, and a part of the solid electrolyte body 31 sandwiched between the electrodes 311 and 312. The first insulator 33A is laid on the first surface 301 of the solid electrolyte body 31. The second insulator 33B is laid on the second surface 302 of the solid electrolyte body 31.

The solid electrolyte body 31 is made of zirconia-based oxide. The solid electrolyte body 31 includes stabilized or partially stabilized zirconia in which a main component is zirconia (containing 50 mass % or more) and in which a part of zirconia is substituted with rare earth metal elements or alkaline earth metal elements. A part of the zirconia containing the solid electrolyte body 31 may be substituted with yttria, scandia, or calcia.

The exhaust electrode 311 and the air electrode 312 contain platinum as a noble metal exhibiting catalytic activity for oxygen and zirconia-based oxide as a common material with the solid electrolyte body 31. The common material is used for maintaining the bond strength between the solid electrolyte body 31 and each of the exhaust electrode 311 and the air electrode 312 formed of an electrode material, when a paste electrode material is printed on (applied to) the solid electrolyte body 31, and the solid electrolyte body 31 and the electrode material is baked.

As shown in FIG. 2, the exhaust electrode 311 and the air electrode 312 are connected with an electrode lead 313 for electrically connecting the exhaust and air electrodes 311 and 312 to a device provided outside the gas sensor 1. The electrode lead 313 is drawn out to a part on the base side L2 of the sensor element 2 in the lengthwise direction L.

### Gas Chamber 35

As shown in FIGS. 2 to 4, the gas chamber 35, surrounded by the first insulator 33A and the solid electrolyte body 31, is formed on and adjacent to the first surface 301 of the solid electrolyte body 31. The gas chamber 35 is formed at a position, at which the exhaust electrode 311 is accommodated, in a part on the tip side L1 of the first insulator 33A in the lengthwise direction L. The gas chamber 35 is formed serving as a space closed by the first insulator 33A, a diffusion resistance portion 32, and the solid electrolyte body 31. The exhaust gas G flowing in the exhaust pipe 7 is introduced into the gas chamber 35 through the diffusion resistance portion 32.

### Diffusion Resistance Portion 32

As shown in FIG. 2, the diffusion resistance portion 32 is provided to be adjacent to the tip side L1 of the gas chamber 35 in the lengthwise direction L. In other words, the diffusion resistance portion 32 is formed on a tip surface 201 of the sensor element 2 in the lengthwise direction L. The diffusion resistance portion 32 is formed in the first insulator 33A by disposing a porous body of a metal oxide such as alumina, in an inlet which is opening and adjacent to the tip side L1 of the gas chamber 35 in the lengthwise direction L. The diffusion rate (flow rate) of the exhaust gas G introduced into the gas chamber 35 is determined by limiting a rate of the exhaust gas G passing through pores of the porous body in the diffusion resistance portion 32.

The diffusion resistance portion 32 may be formed to be adjacent to both sides of the gas chamber 35 in the width direction W. In this case, the diffusion resistance portion 32 is disposed in the first insulator 33A in the inlet which is opening and adjacent to both sides of the gas chamber 35 in the width direction W. In addition, the diffusion resistance portion 32 may also be formed by using pinholes, which are small through-holes communicating with the gas chamber 35, instead of the porous body.

### Air Duct 36

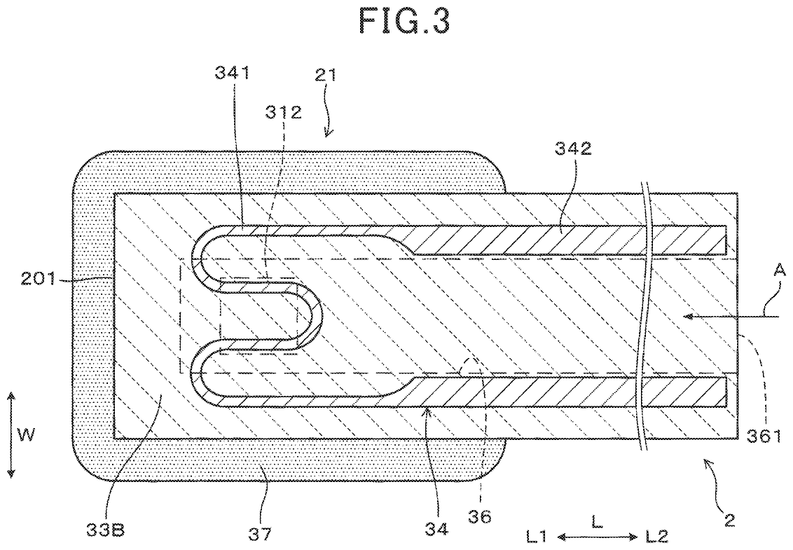

As shown in FIGS. 2 and 3, the air duct 36 surrounded by the second insulator 33B and the solid electrolyte body 31 is formed on and adjacent to the second surface 302 of the solid electrolyte body 31. The air duct 36 is formed from a part of the second insulator 33B, in which the air electrode 312 is accommodated, in the lengthwise direction L to a base side position in the lengthwise direction L of the sensor element 2, which is exposed to the air A. A base side opening 361 serving as an air inlet of the air duct 36 is formed at the base side position in the lengthwise direction L of the sensor element 2. The air duct 36 is formed from the base side opening 361 to a position at which the air duct 36 overlaps with the gas chamber 35 in the lamination direction D via the solid electrolyte element 31. The air A is introduced into the air duct 36 from the base side opening 361.

### Each Insulator 33A, 33B

As shown in FIGS. 2 to 4, the first insulator 33A forms the gas chamber 35. The second insulator 33B forms the air duct 36 and also buries the heating element 34. The first insulator 33A and the second insulator 33B are formed of the metal oxide such as alumina (aluminum oxide). Each insulator 33A, and 33B is provided as dense materials through which the exhaust gas G or the air A cannot pass. Only very few pores are formed in each insulator 33A, 33B through which the gas can pass.

### Terminal Portion 22 of Sensor Element 2

As shown in FIGS. 1 and 2, each terminal portion 22 of the sensor element 2 is electrically connected to respective electrode leads 313 of the exhaust electrode 311 and the air electrode 312. Each terminal portion 22 of the sensor element 2 is electrically connected to respective base side portions in the lengthwise direction L, of a pair of heater element leads 342 described below. Each terminal portion 22 is disposed on both side surfaces at a base side portion of the sensor element 2 in the lengthwise direction L. The base side portions of each electrode lead 313 and heating element lead 342 in the lengthwise direction L are connected to the terminal portions 22 via through holes formed in each insulator 33A, 33B.

### Other Configuration of Sensor Element 2

Although the figure is omitted, the sensor element 2 is not limited to a configuration with one solid electrolyte body 31. The sensor element 2 may be configured with two or more solid electrolyte bodies 31. The exhaust electrode 311 and the air electrode 312 provided in the solid electrolyte body 31 are not limited to a configuration with a single set of electrodes. The exhaust electrode 311 and the air electrode 312 may be configured with multiple sets of electrodes.

### Heater Element 34

As shown in FIGS. 2 to 4, the heating element 34 is buried in the second insulator 33B forming the air duct 36. The heating element 34 has a heating portion 341 generating heat by energization and the heater element lead 342 which is extended to the base side L2 of the heating portion 341 in the lengthwise direction L. The heating portion 341 is disposed at a position at which at least part thereof overlaps with the exhaust electrode 311 and the air electrode 312 in the lamination direction D of the solid electrolyte body 31 and each insulator 33A, 33B. The heating element 34 may be buried in the first insulator 33A.

The heating portion 341 is formed by a meandering linear conductor part with a straight part and a curved part. The straight part of the heating portion 341 of the present embodiment is parallel to the lengthwise direction L. The heater element lead 342 is formed by a straight conductor part parallel to the lengthwise direction L. A resistance per a predetermined length of the heater element 341 is greater than the resistance per the predetermined length of the heater element lead 342. The heater element lead 342 is drawn out from the heater element 341 to a part on the base side L2 in the lengthwise direction L2. The heater element 34 contains a conductive metallic material.

### Protective Layer 37

As shown in FIG. 1, a protective layer 37 is made of a porous ceramic material. The protective layer 37 is composed of a plurality of ceramic particles bonded to each other. Pores (voids) are formed between the ceramic particles that allow the exhaust gas G to pass through.

### Housing 41

As shown in FIG. 1, the housing 41 is used to tighten the gas sensor 1 in the mounting opening 71 of the exhaust pipe 7. The housing 41 has a flange portion 411 configuring a maximum outer diameter portion, a tip side cylinder portion 412 formed on the tip side L1 of the flange portion 411 in the lengthwise direction L, and a base side cylinder portion 413 formed on the base side L2 of the flange portion 411 in the lengthwise direction L. A male thread tightened to a female thread of the mounting opening 71 is disposed around an outer periphery of a part of the base side L2 in the lengthwise direction L, of the tip side tubular portion 412.

### Insulator 42

As shown in FIGS. 1 and 5, an insulator 42 is disposed in the retaining hole 410, which penetrates in the lengthwise direction L, a center part of the housing 41. The insulator 42, also called a first insulator, is composed of an insulating ceramic material. An insertion hole 420 penetrating in the lengthwise direction L is formed in the center part of the insulator 42 to insert the sensor element 2 thereinto. A concave portion 421 in which the sealing member 5 is disposed is formed in communication with an end portion of the base side L2 in the lengthwise direction L of the insertion hole 420. The sensor element 2 is fixed to the insulator 42 by the sealing member 5 disposed in the concave portion 421 in a state where the sensor element 2 is inserted into the insertion hole 420 of the insulator 42.

As shown in FIG. 6, the concave portion 421 is formed by an inner bottom surface 421a serving as an inner end surface in the lengthwise direction L and an annular inner wall 421e perpendicular to the inner bottom surface 421a. A cross-sectional area orthogonal to the lengthwise direction L of the concave portion 421 is larger than a cross-sectional area orthogonal to the lengthwise direction L of the insertion hole 420. The opening edge portion 421b in the inner bottom surface 421a of the concave portion 421 corresponds to a center part of the inner bottom surface 421a, located near the insertion hole 420. An outer circumferential portion 421c corresponds to an outer part of the inner bottom surface 421a, located near the inner wall surface 421e. A remaining portion 421d corresponds to a part of the inner bottom surface 421a other than the opening edge portion 421b and the outer circumferential portion 421c. The opening edge portion 421b and the outer circumferential portion 421c protrude more than the remaining portion 421d. Protrusion refers to a state of being raised from the inner bottom surface 421a toward an opening side (base side L2 of the sensor element 2) of the insulator 42 in the lengthwise direction L.

A protrusion height of the opening edge portion 421b of the present embodiment is formed to be 20 μm or more higher than a height of the surrounding portions. In other words, the opening edge portion 421b is formed to protrude more than 20 μm from the remaining portion 421d of the inner bottom surface 421a toward the opening side (base side L2) in the lengthwise direction L. This configuration improves the sealing effect between the insulator 42 and sensor element 2 when using the sealing member 5. The protrusion height of the opening edge portion 421b may be, for example, in a range of 20 μm or more and 200 μm or less.

The opening edge portion 421b of the present embodiment is formed serving as a protrusion portion 422 protruding annularly. The insertion hole 420 of the insulator 42 is formed serving as a square hole according to the sensor element 2 whose cross-section orthogonal to the lengthwise direction L is formed in a square shape. The protrusion portion 422 protrudes in a square and annular shape around the insertion hole 420. The cross-sectional area of the insertion hole 420 is larger than a cross-sectional area orthogonal to the lengthwise direction L of the sensor element 2. A gap S is formed between the insertion hole 420 and the sensor element 2.

The outer circumferential portion 421c is formed serving as a tapered part in a corner where the inner bottom surface 421a and the inner wall surface 421e meet. The protrusion height of the outer circumferential portion 421c may be, for example, in a range of 20 μm or more and 200 μm or less.

The insulator 42 is formed by compressing and molding a granular ceramic material and heating a molding body. The inner bottom surface 421a and the inner wall surface 421e in the concave portion 421 of the insulator 42 are formed with concave and convex parts made of the granular ceramic material. A surface roughness of each of the inner bottom surface 421a and the inner wall surface 421e in the concave portion 421 of the insulator 42 is 10 μm or less in the ten-point average roughness Rz. This configuration facilitates the sealing member 5 to adhere closely to the inner bottom surface 421a and the inner wall surface 421e, and makes it easier to ensure airtightness with the sealing member 5. The protrusion height of the protrusion portion 422 serving as the opening edge portion 421b is higher than a height of a convex part of the concave and convex parts on the inner bottom surface 421a.

As shown in FIG. 1, an outer periphery side of the insulator 42 is provided with a projection portion (flange) 423 forming the maximum outer diameter portion of the insulator 42. In a state where the insulator 42 is disposed in the retaining hole 410 of the housing 41, a sealing material 424 is disposed on the tip side L1 in the lengthwise direction L of the projection portion 423. In the retaining hole 410, materials 425, 426, 427 for caulking are disposed on the base side L2 in the lengthwise direction L of the projection portion 423. The materials 425, 426, 427 for caulking include a powder sealing material 425, a tubular body 426, and a caulking material 427. The insulator 42 is caulked and fixed in the retaining hole 410 of the housing 41 via the sealing material 424 and the materials 425, 426, 427 for caulking by bending a caulking portion 414 of the base side cylinder portion 413 of the housing 41 to an inner periphery side in a radial direction R.

### Sealing Member 5

As shown in FIGS. 5 and 6, the sealing member 5 is formed by melting and solidifying various granular ceramic materials or compressing various granular ceramic materials. The sealing member 5 may be made of the glass obtained by melting and solidifying a glass material. The sealing member 5 may be made of ceramics obtained by compressing ceramic powder, excluding a glass material.

The sealing member 5 may also contain talcum powder as the ceramic powder. The entire sealing member 5 may be formed as the compacted talcum powder. The talc has excellent heat resistance and is the softest of all inorganic minerals. The compaction of the talcum powder causes the sealing member 5 to adhere closely to each of the insulator 42 and the sensor element 2. This configuration enhances the sealing effect between the insulator 42 and the sensor element 2.

The sealing member 5 may be made of a glass layer 51, in which the glass material is melted and solidified, and a ceramic layer 52, in which the ceramic powder, excluding the glass material, is compressed. The glass layer 51 and ceramic layer 52 are laminated in the lengthwise direction L serving as an insertion direction of the sensor element 2. The ceramic layer 52 may be a compacted layer of the talcum powder.

The sealing member 5 is disposed in the concave portion 421 of the insulator 42, where the sensor element 2 is retained. The sealing section 5 is also disposed in the gap S between the insertion hole 420 of the insulator 42 and the sensor element 2. The sensor element 2 is retained in the insulator 42 by the sealing member 5.

As shown in FIG. 7, the sealing member 5 has the ceramic layer 52 disposed on both sides of the glass layer 51, in the lengthwise direction L. In other words, the sealing member 5 may be formed in a state where the glass layer 51 is disposed between the ceramic layers 52, in the lengthwise direction L. This configuration effectively enhances the sealing effect between the insulator 42 and the sensor element 2.

### Auxiliary Insulator 43

As shown in FIG. 1, an auxiliary insulator 43 is disposed at the base side L2 of the insulator (first insulator) 42 in the lengthwise direction L. The auxiliary insulator 43 holds a contact terminal 44 contacting the terminal portion 22 of the sensor element 2. The auxiliary insulator 43, also called a second insulator, is composed of an insulating ceramic material. An insertion hole 430 penetrating in the lengthwise direction L is formed in a center part of the auxiliary insulator 43 to insert the sensor element 2 thereinto. A groove portion 431 in which the contact terminal 44 is disposed is formed at a position of the auxiliary insulator 43 communicating with the insertion hole 430. The auxiliary insulator 43 is disposed on the inner periphery side in the radial direction R of a base side cover 46A. The auxiliary insulator 43 is pressed against the insulator 42 via a plate spring 433 by the base side cover 46A.

### Contact Terminal 44

As shown in FIG. 1, the contact terminal 44 contacts the terminal portion 22 of the sensor element 2 to electrically connect the portion terminal 22 to a lead wire 48. The contact terminal 44 is disposed in the groove portion 431 of the auxiliary insulator 43. The contact terminal 44 is connected to the lead wire 48 via a connection fitting 441 and contacts the terminal portion 22 by the action restoring force of elastic deformation. A plurality of contact terminals 44 are arranged, the number of the contact terminals 44 corresponding to the number of terminal portions 22 in the sensor element 2. In other words, a plurality of contact terminals 44 are arranged, the number of the contact terminals 44 corresponding to the number of each electrode lead 313 of the exhaust and air electrodes 311, 312, and the pair of heating element leads 342.

### Tip Side Covers 45A, 45B

As shown in FIG. 1, each tip side cover 45A, 45B covers the detector 21 of the sensor element 2 protruding from an end surface on the tip side L1 of the housing 41 in the lengthwise direction L to the tip side L1. Each tip side cover 45A, 45B is attached to the tip side cylinder portion 412 of the housing 41. Each gas flow hole 451, through which exhaust gas G can flow, is formed in each tip side cover 45A, 45B.

The detector 21 of the sensor element 2 and the respective tip side covers 45A, 45B are disposed in the exhaust pipe 7 of the internal combustion engine. Part of the exhaust gas G flowing through the exhaust pipe 7 flows from gas flow holes 451 of the tip side covers 45A, 45B into the tip side covers 45A, 45B. The exhaust gas G in each tip side cover 45A, 45B passes through the protective layer 37 and diffusion resistance portion 32 of the sensor element 2 and is introduced to the exhaust electrode 311.

### Base Side Covers 46A, 46B

As shown in FIG. 1, each base side cover 46A, 46B covers a wiring part located on the base side L2 of the gas sensor 1 in the lengthwise direction L. Each base cover 46A, 46B protects the wiring part from water and the like, in the air A. The wiring part includes the contact terminal 44, which serves as a part electrically connected to the sensor element 2, and the connection fitting 441 between the contact terminal 44 and the lead wire 48.

The base side covers 46A, 46B are formed in two separate components to sandwich a water repellent filter 462 for preventing water in the air A from entering the gas sensor 1. A bush 47 retaining a plurality of lead wires 48 is provided with the inner periphery side of a portion on the base side L2 of the base side cover 46B in the lengthwise direction L. The water repellent filter 462 is sandwiched between the base side covers 46A, 46B and between the base side cover 46B and the bush 47.

The base side cover 46B is formed is formed an air introduction hole 461 for introducing the air A from outside of the gas sensor 1. The water repellent filter 462 is disposed in a state of covering the air introduction hole 461 from the inner periphery side of the base side cover 46B. In the sensor element 2, the base side opening 361 of the air duct 36 is open to a space in each base cover 46A, 46B. The air A, which has passed through the water repellent filter 462 and is drawn into the base side covers 46A, 46B, flows through the base side opening 361 of the air duct 36 of the sensor element 2 into the air duct 36 and is introduced to the air electrode 312 in the air duct 36.

### Bush 47 and Lead Wire 48

As shown in FIG. 1, the bush 47 is disposed on the inner periphery side of base side cover 46B to retain a plurality of lead wires 48. The bush 47 serves as a sealing material. Therefore, the bush 47 is made of, for example, a rubber material having elastic deformability. The bush 47 is provided with a through hole into which lead wire 48 is inserted. The base side cover 46B is caulked to the bush 47, whereby gaps between the lead wires 48 and the through holes, and a gap between the bush 47 and the base side cover 46B are sealed. The lead wire 48 connects the contact terminal 44 to a sensor control unit 6 provided outside the gas sensor 1.

### Sensor Control Unit 6

As shown in FIG. 1, the lead wire 48 of the gas sensor 1 is electrically connected to the sensor control unit 6, which controls gas measurement of the gas sensor 1. The sensor control unit 6 performs electrical control of the gas sensor 1 in cooperation with an engine control unit, which controls the combustion operation of the internal combustion engine. As shown in FIG. 2, the sensor control unit 6 includes a current measurement circuit 61, a voltage application circuit 62, an energizing circuit, and the like. The current measurement circuit 61 measures a current flowing between the exhaust electrode 311 and the air electrode 312. The voltage application circuit 62 applies a voltage between the exhaust electrode 311 and the air electrode 312. The energizing circuit energizes the heater elements 34. The sensor control unit 6 may be configured in the engine control unit.

### Another Gas Sensor 1

The gas sensor 1 may also be served as a sensor to measure a concentration of specific gas components such as NOx (nitrogen oxide). The NOx sensor is provided with a pump electrode which pumps oxygen to the air electrode 312 on the solid electrolyte body 31 by applying voltage. The pump electrode is disposed upstream of the flow of the exhaust gas G contacting the exhaust electrode 311 on the solid electrolyte body 31. The air electrode 312 is also formed at a position at which at least part thereof overlaps with the pump electrode in the lamination direction D via the solid electrolyte body 31.

### Method of Manufacturing Gas Sensor 1

As shown in FIG. 5, when manufacturing the gas sensor 1, the sensor element 2 is inserted into the insertion hole 420 of the insulator 42. Next, the glass or the ceramic powder, which constitutes the sealing member 5, is disposed in the concave portion 421 of the insulator 42 in which the sensor element 2 is retained. A part of the glass or the ceramic powder is also disposed from the concave portion 421 into the gap S of the insertion hole 420 through which the sensor element 2 is inserted. An intermediate body with the sensor element 2, the insulator 42, and the sealing member 5 assembled is then heated for the heat treatment.

When the temporarily baked solid glass is used as the sealing member 5, the glass melts due to the intermediate body being heated. In the initial stage of softening, the glass is deformed so that it clings to the sensor element 2 due to surface tension. The softened glass adheres closely to the protrusion portion 422 serving as the opening edge portion 421b of the inner bottom surface 421a. In particular, when the temperature of the above heat treatment is increased to higher temperature to improve the heat resistance and the water resistance of the gas sensor 1, the sealing member 5 may use glass with a higher melting point. In this case, the wettability of the glass may decrease. However, the high-temperature heat treatment causes the glass to adhere to the protrusion portion 422. This ensures the airtightness between the insulator 42 and the sensor element 2 by the sealing member 5.

When the ceramic powder is used as the sealing member 5, the protrusion portion 422 serving as the opening edge portion 421b is formed on the inner bottom surface 421a to increase the pressure applied to the ceramic powder from the protrusion portion 422 and the sensor element 2 near the protrusion portion 422. Therefore, the gas sensor can ensure the airtightness between the insulator 42 and the sensor element 2 by the sealing member 5.

The gas sensor 1 manufactured in the above manner enhances the sealing effect between the insulator 42 and the sensor element 2, even when the glass or the ceramic powder is used for the sealing member 5. The gas sensor 1 then prevents the exhaust gas G from leaking into the air A through the gap between the insulator 42 and the sensor element 2.

### Action Effect

In the gas sensor 1 of the present embodiment, the opening edge portion 421b in the inner bottom surface 421a of the concave portion 421 of the insulator 42, which is connected to the insertion hole 420, protrudes more than the other portions surrounding the opening edge portion 421b. As a result, when the gas sensor 1 locales the sealing member 5 in the concave portion 421 of the insulator 42 to hold the sensor element 2 in the insulator 42, the sealing member 5 contacts the opening edge portion 421b protruding from the inner bottom surface 421a of the concave portion 421. Thus, the gas sensor 1 can easily allow the sealing member 5 to contact the insulator 42. Furthermore, the gas sensor 1 can increase an area of contact between the sealing member 5 and the insulator 42 due to the sealing member 5 contacting the opening edge portion 421b.

According to the gas sensor 1 of the present embodiment, it is possible to effectively enhance the sealing effect between the insulator 42 and the sensor element 2 when using the sealing member 5.

The present disclosure is not limited to the above-described embodiments, and can be applied to various embodiments within the scope that does not depart from the gist of the present disclosure. This disclosure also includes various variation examples or variations within the equivalent scope. Furthermore, the technical concept of this disclosure also includes various combinations of components, forms, and the like, envisioned from this disclosure.

The present disclosure has been described in accordance with embodiments. However, it is understood that the present disclosure is not limited to the embodiments and configurations. The present disclosure also encompasses various variation examples or variations within the equivalent scope. In addition, various combinations and forms, and furthermore, other combinations and forms which include only one component, more than that, or less than that, in the various combinations or embodiments also fall within the category or conceptual scope of the present disclosure.

What is claimed is:

1. A gas sensor, comprising:
a sensor element measuring a gas concentration;
an insulator having:
an insertion hole through which the sensor element is inserted; and
a concave portion, in which the sensor element communicated with the insertion hole is continuously disposed from the insertion hole,
a sealing member which is disposed in the concave portion to hold the sensor element to the insulator; and
a housing with a retaining hole to hold the insulator, wherein
an opening edge portion in the inner bottom surface of the concave portion, which connects to the insertion hole, protrudes more than other portions surrounding the opening edge portion.

2. The gas sensor according to claim 1, wherein
the opening edge portion is 20 μm or more higher than the surrounding portions thereof.

3. The gas sensor according to claim 1, wherein
the opening edge portion is formed serving as a protrusion portion protruding annularly.

4. The gas sensor according to claim 1, wherein
the sealing member contains talcum powder.

5. The gas sensor according to claim 1, wherein
the sealing member has:
a glass layer, in which a glass material is melted and solidified; and
a ceramic layer, in which ceramic powder, excluding the glass material, is compressed,
the glass layer and ceramic layer are laminated in an insertion direction of the sensor element.

6. The gas sensor according to claim 1, wherein
an inner surface roughness of the concave portion of the insulator is 10 μm or less in ten-point average roughness Rz.
